(19) United States
(12) Patent Application Publication
(10) Pub. No.: US 2008/0020142 A1
(43) Pub. Date: Jan. 24, 2008

(54) Elastic Artificial Leather

(76) Inventors: Chung-Chih Feng, Kaohsiung (TW); Kuo-Kuang Cheng, Kaohsiung Hsien (TW); Chih-Yi Lin, Kaohsiung (TW); Chiao-Fa Yang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/781,747

(22) Filed: Jul. 23, 2007

Related U.S. Application Data
(62) Division of application No. 11/106,119, filed on Apr. 14, 2005.

(30) Foreign Application Priority Data
Sep. 16, 2004 (TW) 093128093

(51) Int. Cl. B05D 3/10

(52) U.S. Cl. 427/342

(57) ABSTRACT

A method for producing elastic artificial leather includes preparing two polymers that include different crystallization degrees but similar fluidities. Fibers are made of the polymers, and non-woven cloth is made of the fibers. The non-woven cloth is then soaked in polyurethane resin. The non-woven cloth and the polyurethane resin are washed and then dried. In another method, a first type of fibers made of the polymers is mixed with a second type of fibers that can be dissolved in water, alkali or organic solvent. A non-woven cloth made of the first and second types of fibers and is soaked in polyurethane resin. The second type of fibers are then from the non-woven cloth and the polyurethane resin in order to leave elongated spaces. With either method, the recovery rate of the elastic artificial leather is above 90% after it is stretched by 10% to 200% longitudinally and transversely.

### CROSS REFERENCE TO RELATED APPLICATION

This is a divisional application of U.S. patent application Ser. No. 11/106,119 filed Apr. 14, 2005.

### BACKGROUND OF INVENTION

The present invention relates to elastic artificial leather.

Ordinary artificial leather is made through coating a non-woven substrate with polyurethane (PU) resin or submerging a non-woven substrate in PU resin. A non-woven substrate exhibits sufficient strength but inadequate elasticity. When used in artificial leather, it is vulnerable to wrinkle when stretched and cannot adequately be processed by hot-molding press. This is not desirable. To improve the elasticity, efforts have been made about the shapes of the fibers of which non-woven cloth is made. Japanese Patent Publication 2000-248431 discloses a conjugate fiber and a method of making stretchable non-woven cloth from such conjugate fibers. In this conventional method, polymers that include different molecular numbers are used to form a spiral fiber through parallel spinning. Such fibers are highly curly when made. However, they become much less curly after going through needling or spun-lacing. Artificial leather made of such needled or spun-laced fibers is inadequately elastic.

Other efforts have been made about the structures of the fibers of which the non-woven cloth is made. Elastic thermo-plastic polymers are used to make elastic fibers. The non-woven cloth and artificial leather made of the elastic fibers are known to be elastic. Such artificial leather is disclosed in U.S. Pat. Nos. 6,767,853 and 6,451,716 for example. Such artificial leather is elastic but not weak. To provide sufficient strength to the artificial leather, the elastic fibers are mixed with non-elastic fibers; however, such mixture reduces the elasticity of the artificial leather.

### SUMMARY OF THE INVENTION

The present invention is therefore intended to obviate or at least alleviate the problems encountered in prior art. Focused on the materials of fibers of which artificial leather is made, in a method according to the present invention, polymers are used to form curly fibers, and the curly fibers are used to make non-woven cloth. The non-woven cloth is highly elastic and is not vulnerable to wrinkles when stretched and cannot adequately be processed by hot-molding press.

Two polymers that include different crystallization degrees but include similar fluidities are used to form highly stretchable fibers through spinning. The crystallization degree of the first polymer is about 40% to 95%. The crystallization degree of the second polymer is about 1% to 25%.

The first polymer may be nylon 6, nylon 66, nylon, polyethylene terephthalate (PET), polypropylene terephthalate (PPT), polybutylene terephthalate (PBT), polyethylene (PE), polypropylene (PP), polymethylpentene or polyolefin. To render the fiber as curly as possible, the crystallization degree of the first polymer is preferably 40% to 95%. If the crystallization degree of the first polymer is below 40%, the artificial leather will not be elastic because the difference between the crystallization degrees is small (below 15%) and the fibers are not curly although the first and second polymers are used to make the fibers through conjugate spinning and such fibers are used to make the non-woven cloth through needling.

The second polymer may be adipic acid, azeloaic acid, terephthalic acid, isophthalic acid, cyclohexane-1,4-dicarboxylic acid, 1,6-diaminohexane, caprolactam, 4,4′-diphenylmethane dissocyanate, tolylene diisocyanate, p-hydroxybenzoic acid, isophthalic acid, diol, diester or nylon (polyamide). To render the fiber as curly as possible, the difference between the crystallization degrees is preferably higher than 15%, and the crystallization degree of the second polymer is preferably 1% to 25%.

Through conjugate spinning, the fibers made of the polymers that include different crystallization degrees but similar fluidities may include a side-by-side structure or a sheath-and-core structure. The spinning takes place at 150 to 300° C. at a speed of 1000 to 2000 m/min. The fibers are extended at 70 to 90° C. and dried and cut. Because the viscosities of the polymers are alike (the difference between the fluidities of the polymers is lower than 5 g/10 min), the fibers are not highly curly. Non-woven cloth is made of such fibers through needling and spinning. The non-woven cloth is soaked in water at 50 to 90° C. The fibers shrink and become curly because the polymers that include different crystallization degrees shrink to different extents. The non-woven cloth is soaked in PU resin and absorbs PU resin 0.5 to 3.0 times as much as the non-woven cloth. The non-woven cloth exchanges with water with 5% to 50% of dimethylformamide (DMF) and is washed with water at 50 to 100° C. and dried at 100 to 180° C. Thus, cells are formed in the artificial leather so that the artificial leather is elastic.

To further increase the elasticity of the artificial leather, the non-woven cloth may include, in addition to the fibers (“first type of fibers”), additional fibers (“second type of fibers”) that can be dissolved in water, alkali or solvent. The second type of fibers is formed from a polymer (“third polymer”) with a low crystallization degree. The third polymer is mixed with the first and second polymers that form the first type of fibers. The mixture of the polymers forms the first and second types of fibers through spinning. Alternatively, the second type of fibers is mixed with the first type of fibers. The non-woven cloth is made of the first and second types of fibers through needling or spun-lacing. The non-woven cloth is soaked in water at 50 to 90° C. so that the first type of fibers becomes curly. The non-woven cloth is soaked in PU resin. The non-woven cloth is soaked in methylbenzene, perchloroethylene, sodium hydroxide or hot water in order to dissolve the second type of fibers. As the second type of fibers is removed, spaces with 5 to 50 micrometers wide and 20 to 100 mm long are left in the PU resin in order to form highly elastic artificial leather.

The third polymer may be polyethylene terephthalate (“PET”), polyethylene (“PE”), polystyrene (“PS”) or polyvinyl alcohol (“PVA”) that can be dissolved later. The weight of the second type of fibers may take 10% to 50% of the weight of the non-woven cloth. When the percentage is below 10%, insufficient spaces are left in the PU resin after the second type of fibers is removed so that the artificial leather is not sufficiently elastic. When the percentage is above 50%, many spaces are left in the PU resin after the second type of fibers is removed so that the artificial leather easily collapses, i.e., not sufficiently elastic.

The first type of fibers is about 1 to 10 deniers per filament (“dpf”). In consideration of the elasticity and strength, 5 dpf is preferred and 3 dpf is more preferred. The artificial leather according to the present invention exhibits a recovery rate of more than 90% after it is stretched by 10% to 200%.

The artificial leather is put under test in the following conditions:
1. Stretching machine: INSTRON 4465;
2. Tested sample: 15 cm long and 2.54 cm wide;
3. The tested sample is stretched by 5 cm at 300 m/min for five times.
4. The elastic recovery rate depends on the deformation rate after the tested sample is stretched by 10% to 200%.

### BRIEF DESCRIPTION OF DRAWINGS

The present invention will be described via detailed illustration of embodiments referring to the drawings.

FIG. 1 is a cross-sectional view of a first side-by-side structure of a fiber made from two polymers that include different crystallization degrees and similar molten fluidities.

FIG. 2 is a cross-sectional view of a second side-by-side structure of a fiber made from two polymers that include different crystallization degrees and similar molten fluidities.

FIG. 3 is a cross-sectional view of a third side-by-side structure of a fiber made from two polymers that include different crystallization degrees and similar molten fluidities.

FIG. 4 is a cross-sectional view of a sheath-and-core structure of a fiber made from two polymers that include different crystallization degrees and similar molten fluidities.

FIG. 5 is an SEM photograph, magnified for 200 times, of artificial leather made of fibers made according to a first embodiment of the present invention, showing curling of the first fibers after heating.

FIG. 6 is an SEM photograph, magnified for 500 times, of artificial leather made of fibers made according to the second to fifth embodiments of the present invention, showing voids formed after removal of the second fibers.

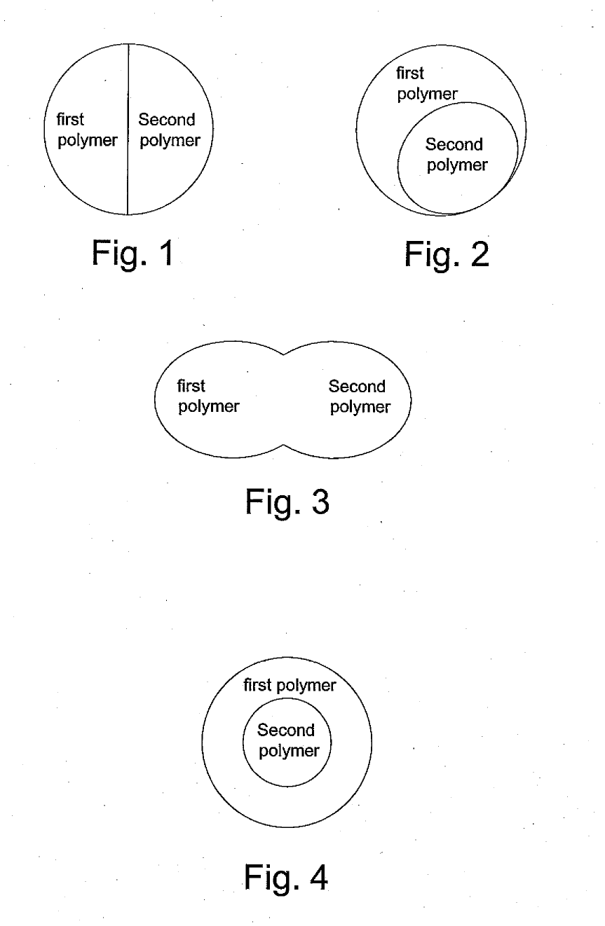

### DETAILED DESCRIPTION OF EMBODIMENTS

### First Embodiment

Two types of polyethylene terephthalate (PET) that include different crystallization degrees but similar fluidities are used. The first type of PET includes a crystallization degree of 30% and a stickiness IV of 0.63. The second type of PET includes a crystallization degree of 5% and a stickiness IV of 0.6. The types of PET are used to make fibers at a ratio of 50:50 through conjugate spinning. The spinning nozzle is operated at 295° C. at 1100 m/min. The fibers are stretched at 80° C. and dried and cut. Thus, fibers of3 dpf and 51 mm in length are made. These fibers are made into even webs by a carding machine. The webs are made into non-woven cloth by a cross lapper. The non-woven cloth is subject to needling at 1200 stitch/m² and caused to shrink at hot water of 85° C.

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth and the mixture are washed in water at 95° C. and dried at 140° C. Finally, artificial leather of 255 g/m² is made.

The artificial leather is put under recovery tests. It is stretched by 30%. The results are shown in the following table.

TABLE 1

| | Longitudinal Recovery Rate (%) | Transverse Recovery Rate (%) |
|---|---|---|
| 1 | 93.9 | 96.94 |
| 2 | 92.77 | 96.35 |
| 3 | 92.79 | 95.98 |
| 4 | 92.58 | 94.77 |
| 5 | 91.98 | 95.92 |
| Average | 92.70 | 95.99 |

### Second Embodiment

According to a second embodiment, before fed to the carding machine, the fibers made according to the first embodiment are mixed with 35% of polyvinyl alcohol (PVA) fibers of 3 dpf and 51 mm long. These fibers are made into even webs by the carding machine. The webs are made into non-woven cloth by the cross lapper. The non-woven cloth is subject to needling at 1200 stitch/m² and caused to shrink at hot water of 85° C.

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth and the mixture are washed in water at 95° C. and dried at 140° C. Finally, artificial leather of 256 g/m² is made.

The artificial leather is put under recovery tests. It is stretched by 30%. The results are shown in the following table.

TABLE 2

| | Longitudinal Recovery Rate (%) | Transverse Recovery Rate (%) |
|---|---|---|
| 1 | 96.15 | 98.52 |
| 2 | 96.04 | 98.66 |
| 3 | 96.24 | 98.47 |
| 4 | 96.19 | 98.42 |
| 5 | 96.57 | 98.21 |
| Average | 96.24 | 98.46 |

### Third Embodiment

According to a third embodiment, before fed to the carding machine, the fibers made according to the first embodiment are mixed with 35% of CO-PET fibers of 3 dpf and 51 mm long. These fibers are made into even webs by the carding machine. The webs are made into non-woven cloth by the cross lapper. The non-woven cloth is subject to needling at 1200 stitch/m² and caused to shrink at hot water of 85° C.

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth and the mixture are washed in water at 95° C. and dried at 140° C. Finally, artificial leather of 245 g/m² is made.

The artificial leather is put under recovery tests. It is stretched by 30%. The results are shown in the following table.

TABLE 3

| | Longitudinal Recovery Rate (%) | Transverse Recovery Rate (%) |
|---|---|---|
| 1 | 96.87 | 98.23 |
| 2 | 97.23 | 98.55 |
| 3 | 96.86 | 98.64 |
| 4 | 96.74 | 96.33 |
| 5 | 96.81 | 97.87 |
| Average | 96.90 | 97.92 |

### Fourth Embodiment

According to a fourth embodiment, before fed to the carding machine, the fibers made according to the first embodiment are mixed with 35% of polyethylene(PE) fibers of 3 dpf and 51 mm long. These fibers are made into even webs by the carding machine. The webs are made into non-woven cloth by the cross lapper. The non-woven cloth is subject to needling at 1200 stitch/m² and caused to shrink at hot water of 85° C.

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth is washed in water at 95° C. and dried at 140° C. The PE fibers are dissolved in perchloroethylene. The non-woven cloth and the resin are washed in water at 95° C. Finally, artificial leather of 252 g/m² is made.

The artificial leather is put under recovery tests. It is stretched by 30%. The results are shown in the following table.

TABLE 4

| | Longitudinal Recovery Rate (%) | Transverse Recovery Rate (%) |
|---|---|---|
| 1 | 95.64 | 96.73 |
| 2 | 94.63 | 98.32 |
| 3 | 95.33 | 97.66 |
| 4 | 94.89 | 96.45 |
| 5 | 95.66 | 96.88 |
| Average | 95.23 | 97.21 |

### Fifth Embodiment

According to a fifth embodiment, before fed to the carding machine, the fibers made according to the first embodiment are mixed with 35% of Polystyrene (PS) fibers of 3 dpf and 51 mm long. These fibers are made into even webs by the carding machine. The webs are made into non-woven cloth by the cross lapper. The non-woven cloth is subject to needling at 1200 stitch/m² and caused to shrink at hot water of 85° C.

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth and the mixture are washed in water at 95° C. and dried at 140° C. Finally, artificial leather of 248 g/m² is made.

The artificial leather is put under recovery tests. It is stretched by 30%. The results are shown in the following table.

TABLE 5

| | Longitudinal Recovery Rate (%) | Transverse Recovery Rate (%) |
|---|---|---|
| 1 | 95.88 | 98.21 |
| 2 | 96.21 | 98.55 |
| 3 | 95.64 | 98.11 |
| 4 | 95.33 | 98.20 |
| 5 | 95.22 | 97.42 |
| Average | 95.66 | 98.10 |

### Prior Art Reference

PET fibers of 3 dpf and 51 mm in length are made into even webs by the carding machine. The webs are made into non-woven cloth by the cross lapper. The non-woven cloth is subject to needling at 1200 stitch/m².

PU resin and DMF are mixed at a ratio of 40:60. The non-woven cloth is soaked in the mixture. The non-woven cloth absorbs the mixture about 1.8 times as heavy as itself. Exchange is conducted between water and 25% DMF at 25° C. The non-woven cloth and the mixture are washed in water at 95° C. and dried at 140° C. Finally, artificial leather of 250 g/m² is made.

The artificial leather is put under recovery tests. It is stretched by 30%. The results are shown in the following table.

TABLE 6

| | Longitudinal Recovery Rate (%) | Transverse Recovery Rate (%) |
|---|---|---|
| 1 | 49.57 | 69.59 |
| 2 | 42.78 | 65.38 |
| 3 | 45.19 | 65.72 |
| 4 | 41.76 | 63.17 |
| 5 | 38.81 | 61.71 |
| Average | 43.68 | 64.76 |

### Effects

The first to fifth embodiments of the present invention are compared with the prior art reference. The results are shown in the following table.

TABLE 7

| | | | | Strength (N/cm) |
|---|---|---|---|---|
| | | Recovery Rate (%) | | DIN 53273 |
| | Weight | Longitudinal | Transverse | Standard |
| | (g/m²) | (MD) | (CD) | Transverse (CD) |
| Reference | 250 | 48.68 | 64.76 | 43.2 |
| 1^{st} embodiment | 255 | 93.90 | 95.99 | 41.6 |
| 2^{nd} embodiment | 256 | 92.77 | 98.46 | 39.6 |
| 3^{rd} embodiment | 245 | 92.79 | 97.92 | 36.4 |
| 4^{th} embodiment | 252 | 92.58 | 97.21 | 38.6 |
| 5^{th} embodiment | 248 | 91.98 | 98.10 | 38.1 |

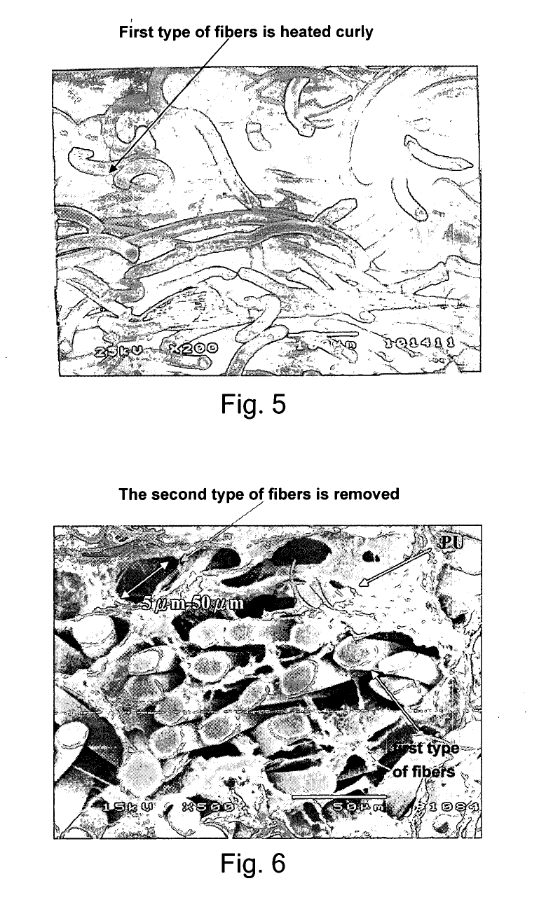

Table 7 shows that the artificial leather according to the first embodiment exhibits high elasticity (the MD recovery rate is 92.70%, the CD recovery rate is 95.99%) and sufficient strength (the CD strength is 41.6 N/cm). The artificial leather according to the first embodiment is less vulnerable to wrinkles when it is stretched than conventional leather (the MD recovery rate is 48.68%, the CD recovery rate is 64.76%) and sufficiently thermoplastic. Referring to FIG. 5, after heated, the fibers curl because their gradients include different crystallization degrees. In the artificial leather according to the second to fifth embodiments, showing in FIG. 6, the non-woven cloth may include, in addition to the fibers used in the first embodiment (“first type of fibers”), additional fibers (“second type of fibers”) that can be dissolved in water, alkali or solvent. The non-woven cloth is made of the first and second types of fibers by the cross lapper. The non-woven cloth is subject to needling or spun-lacing and washed in the hot water. Exchange is conducted between the PU resin and water. The second type of fibers is removed from the artificial leather by hot water, alkali or solvent. Thus, the MD and CD recovery rates of the artificial leather are both above 95% and the CD strength is above 38 N/cm.

In the second, third, fourth and fifth embodiments, the second type of fibers is dissolved and removed, thus leaving spaces 5 to 50 micrometers wide and 20 to 100 mm long in the PU resin in order to form highly elastic artificial leather.

The present invention has been described via detailed illustration of some embodiments. Those skilled in the art can derive variations from the embodiments without departing from the scope of the present invention. Therefore, the embodiments shall not limit the scope of the present invention defined in the claims.

1. A process for producing elastic artificial leather comprising the steps of:
providing two polymers that include different crystallization degrees but similar fluidities;
making fibers of the polymers;
making non-woven cloth of the fibers;
soaking the non-woven cloth in polyurethane resin;
washing the non-woven cloth and the polyurethane resin; and
drying the non-woven cloth and the polyurethane resin so that the recovery rate of the elastic artificial leather is above 90% after it is stretched by 10% to 200% longitudinally and transversely.

2. The process for producing elastic artificial leather according to claim 1 wherein the crystallization degree of the first polymer is 40% to 95%, wherein the crystallization degree of the second polymer is 1% to 25%.

3. The process for producing elastic artificial leather according to claim 2 wherein the first polymer is selected from the group consisting of polyamide 6, polyamide 66, polyamide, polyethylene terephthalate, polypropylene terephthalate, polybutylene terephthalate, polyethylene, polypropylene, polymethylpentene and polyolefin.

4. The process for producing elastic artificial leather according to claim 2 wherein the second polymer is selected from the group consisting of adipic acid, azeloaic acid, terephthalic acid, isophthalic acid, cyclohexane-1,4-dicarboxylic acid, 1,6-diaminohexane, caprolactam, 4,4′-diphenylmethane dissocyanate, tolylene diisocyanate, p-hydroxybenzoic acid, isophthalic acid, diol, diester and polyamide.

5. The process for producing elastic artificial leather according to claim 1 further comprising a step of shrinking the non-woven cloth before soaking the non-woven in polyurethane resin.

6. The process for producing elastic artificial leather according to claim 5 wherein the non woven is caused to shrink in hot water at 50° C. to 90° C. in the step of shrinking the non-woven cloth.

7. A process for producing elastic artificial leather comprising the steps of:
providing first and second polymers that include different crystallization degrees but similar fluidities;
making a first type of fibers of the polymers;
mixing the first type of fibers with a second type of fibers that can be dissolved in water, alkali or organic solvent;
making a non-woven cloth of the first and second types of fibers;
soaking the non-woven cloth in polyurethane resin; and
removing the second type of fibers from the non-woven cloth and the polyurethane resin in order to leave elongated spaces so that the recovery rate of the elastic artificial leather is above 90% after it is stretched by 10% to 200% longitudinally and transversely.

8. The process for producing elastic artificial leather according to claim 7 wherein the crystallization degree of the first polymer is 40% to 95%, wherein the crystallization degree of the second polymer is 1% to 25%.

9. The process for producing elastic artificial leather according to claim 8 wherein the first polymer is selected from the group consisting of polyamide 6, polyamide 66, polyamide, polyethylene terephthalate, polypropylene terephthalate, polybutylene terephthalate, polyethylene, polypropylene, polymethylpentene and polyolefin.

10. The process for producing elastic artificial leather according to claim 8 wherein the second polymer is selected from the group consisting of adipic acid, azeloaic acid, terephthalic acid, isophthalic acid, cyclohexane-1,4-dicarboxylic acid, 1,6-diaminohexane, caprolactam, 4,4′-diphenylmethane dissocyanate, tolylene diisocyanate, p-hydroxybenzoic acid, isophthalic acid, diol, diester and polyamide.

11. The process for producing elastic artificial leather according to claim 8 wherein the first type of fibers are 1 to 10 dpf.

12. The process for producing elastic artificial leather according to claim 7 further comprising a step of shrinking the non-woven cloth before soaking the non-woven in polyurethane resin.

13. The process for producing elastic artificial leather according to claim 12 wherein the non woven is caused to shrink in hot water at 50° C. to 90° C. in the step of shrinking the non-woven.

14. The process for producing elastic artificial leather according to claim 7 wherein the weight of the second type of fibers takes 10% to 50% of the weight of the non-woven cloth.

15. The process for producing elastic artificial leather according to claim 7 wherein the second type of fibers is made of a polymer selected from the group consisting of polyethylene terephthalate, polyethylene, polystyrene or polyvinyl alcohol, and wherein the second type of fibers is 1 to 10 dpf.
